(19) United States
(12) Patent Application Publication
(10) Pub. No.: US 2019/0210328 A1
(43) Pub. Date: Jul. 11, 2019

(54) VISCO-ELASTIC PLASTIC SPACER FOR VIBRO-ACOUSTIC DAMPING AND GLAZING COMPRISING SUCH A SPACER

(71) Applicant: SAINT-GOBAIN GLASS FRANCE, Courbevoie (FR)

(72) Inventors: Stephan GILLESSEN, Alsdorf (DE); Benjamin KREBS, Boschum (DE); Ingo VON DER WEIDEN, Aachen (DE); Gerald MERCIER, Compiegne (FR)

(73) Assignee: SAINT-GOBAIN GLASS FRANCE, Courbevoie (FR)

(21) Appl. No.: 16/316,273

(22) PCT Filed: Jul. 24, 2017
(86) PCT No.: PCT/FR2017/052038

§ 371 Date: Jan. 8, 2019

(30) Foreign Application Priority Data
Jul. 22, 2016 (FR) 1657043

(51) Int. Cl. B32B 17/10; G10K 11/168

(52) U.S. Cl. CPC B32B 17/10761; B32B 17/10036; B32B 2250/246; B32B 2250/05; G10K 11/168

(57) ABSTRACT

A viscoelastic plastic interlayer to be incorporated between two glass sheets of a glazing provides it with vibro-acoustic damping properties. The interlayer includes two outer layers made of standard PVB, first and second inner layers made of viscoelastic plastic material based on polyvinyl acetal and plasticizer, with improved acoustic properties, a central layer made of standard PVB, the first and the second inner layers being arranged, respectively, between the central layer and the first and second outer layers. The viscoelastic plastic interlayer, when incorporated between two glass sheets to form a laminated glazing with vibro-acoustic damping properties, allows an improvement in the acoustic insulation properties, in particular within a frequency range of between 1000 Hz and 5000 Hz, in which range the human ear is the most sensitive.

The invention relates to a viscoelastic plastic interlayer intended to be incorporated between two glass sheets to form a laminated glazing with vibro-acoustic damping properties, intended for locomotive machines, in particular a motor vehicle, or alternatively building insulation.

Among all the qualities contributing to comfort in modern transportation means such as trains and motor vehicles, silence has become a determining factor.

Acoustic comfort has been improved over several years now, by treating noises, such as noise from the engine, rolling or suspension noise, either at their source or during their propagation through the air or through solids.

The shapes of vehicles have also been modified to improve the penetration through air and to reduce the turbulence, which is itself a source of noise.

In recent years, attention has been focused on the role that glazing might play in improving acoustic comfort, in particular laminated glazing comprising plastic interlayer films. Laminated glazing also has other advantages, such as eliminating the risk of projection of fragments in the event of sudden breakage, or alternatively constituting an effraction retarder.

It has been demonstrated that the use of standard plastic films in laminated glazing is unsuitable for improving acoustic comfort. Specific plastic films were then developed, which had damping properties that allowed an improvement in the acoustic comfort.

However, there is constant demand for improvement of the acoustic comfort.

There is thus a need for a viscoelastic plastic interlayer intended to be incorporated between two glass sheets to form a laminated glazing with vibro-acoustic damping properties, which allows an improvement in the acoustic insulation properties, in particular within a frequency range of between 1000 Hz and 5000 Hz, in which range the human ear is the most sensitive.

To do this, the invention proposes a viscoelastic plastic interlayer intended to be incorporated between two glass sheets of a glazing to provide it with vibro-acoustic damping properties, the interlayer comprising:
two outer layers made of standard PVB,
a first and a second inner layers made of viscoelastic plastic material based on polyvinyl acetal and plasticizer, with improved acoustic properties,
a central layer made of standard PVB,

the first and the second inner layers being arranged, respectively, between the central layer and the first and second outer layers.

In the present text, the terms “standard PVB” denote a polyvinyl butyral (PVB) film in which:
the mole content of PVB is greater than 42%, preferentially greater than 44%, preferentially greater than 46%, preferentially greater than 48%, preferentially greater than 50%, preferentially greater than 52%, preferentially greater than 53%, preferentially greater than 53.5%, preferentially greater than 54%, preferentially greater than 54.5%, preferentially greater than 55%, preferentially greater than 55.5%, and is less than 60%, preferentially less than 59.5%, preferentially less than 59%, preferentially less than 58.5%, preferentially less than 58%, preferentially less than 57.5%, preferentially less than 57%, preferentially less than 56.5%,
the mass content of plasticizers expressed as parts per 100 parts of PVB resin (phr) is greater than 5 phr, preferentially greater than 10 phr, preferentially greater than 20 phr, preferentially greater than 22.5 phr, preferentially greater than 25 phr, and is less than 120 phr, preferentially less than 110 phr, preferentially less than 90 phr, preferentially less than 75 phr, preferentially less than 60 phr, preferentially less than 50 phr, preferentially less than 40 phr, preferentially less than 35 phr, preferentially less than 30 phr,
the glass transition temperature for a frequency of 100 Hz is greater than 30° C., preferentially greater than 40° C., and is less than 60° C., preferentially less than 56° C.

According to a particular aspect of the invention, the outer layers and the central layer have a shear modulus G′ of greater than or equal to 1.10⁸ Pa and a tan δ loss factor of less than 0.4, at 20° C. and within a frequency range of between 1 kHz and 10 kHz.

According to at least one embodiment, the interlayer is such that the resonant frequency f1 of the first resonance mode of a laminated glazing bar with a surface area of 25 mm×300 mm composed of two glass sheets each 2.1 mm thick between which is incorporated the interlayer, determined by mechanical impedance measurement (MIM) at 20° C. according to standard ISO 16940, is between 100 Hz and 200 Hz and the modal damping η₁ of said first resonance mode of said bar, determined by MIM under the same conditions, is greater than or equal to 0.35.

According to one aspect of the invention, the interlayer is such that the resonant frequency f1 of the first resonance mode of a laminated glazing bar with a surface area of 25 mm×300 mm composed of two glass sheets 2.1 mm thick between which is incorporated the interlayer, determined by mechanical impedance measurement (MIM) at 20° C. according to standard ISO 16940, is between 120 and 180 Hz and the modal damping η₁ of said first resonance mode of said bar, determined by MIM under the same conditions, is greater than or equal to 0.38, or even 0.40.

According to at least one embodiment, the first and the second inner layers have a different composition.

According to one aspect of the invention, the central layer and the outer layers each have a thickness of between 0.10 mm and 0.40 mm and the inner layers each have a thickness of between 0.10 mm and 0.20 mm, the total thickness of the interlayer being between 0.70 mm and 2.00 mm.

According to at least one embodiment, the central layer is constituted of two layers made of standard PVB, the interlayer being constituted of two superposed three-layer interlayers, each three-layer interlayer comprising two layers made of standard PVB between which is arranged a layer made of viscoelastic plastic material based on polyvinyl acetal, with improved acoustic properties.

According to at least one embodiment, the interlayer is tinted in the bulk on a part of its surface and/or has a cross section decreasing in a wedge shape from the top to the bottom of a laminated glazing into which it is intended to be incorporated and/or comprising particles serving to screen out infrared radiation.

The invention also relates to a laminated glazing comprising:
a glass sheet with a thickness of between 0.5 mm and 3.0 mm,
a glass sheet with a thickness of between 0.5 mm and 3.0 mm,
an interlayer as described above, the interlayer being between the glass sheets.

The invention furthermore relates to a laminated glazing comprising:
a glass sheet with a thickness of between 0.5 mm and 15.0 mm,
a glass sheet with a thickness of between 0.5 mm and 15.0 mm,
an interlayer as described above, the interlayer being between the glass sheets.

The invention furthermore relates to the use of the glazing described above as motor vehicle glazing.

Alternatively, the invention relates to the use of the glazing described above as glazing for buildings, either as single glazing, or integrated into multiple glazing.

Other characteristics and advantages of the invention will now be described with regard to the drawings, in which:

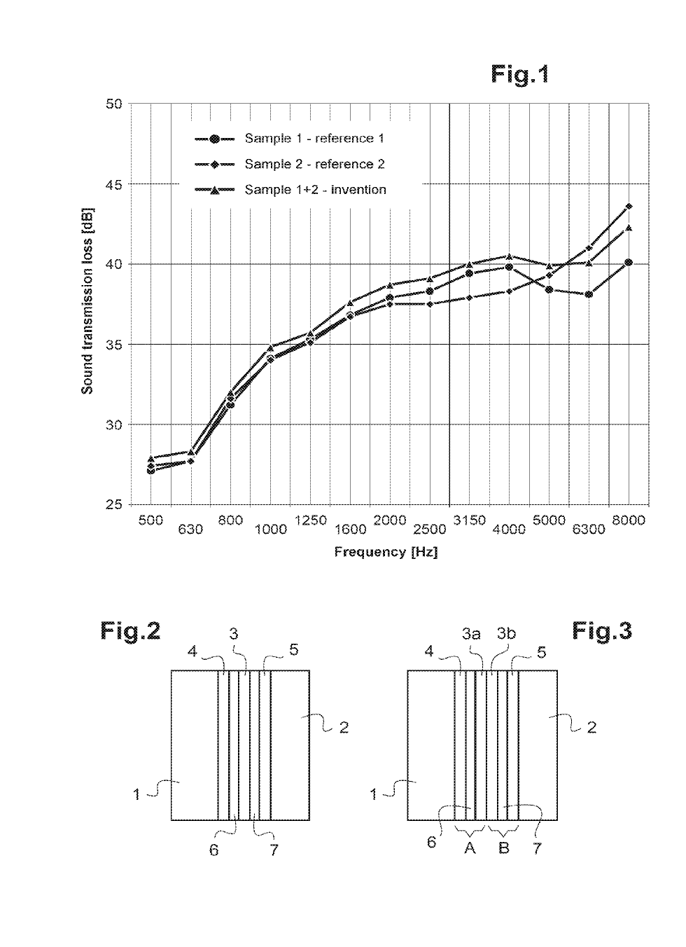

FIG. 1 represents an evaluation of the sound transmission loss (STL) as a function of the frequency for three different laminated glazings;

FIG. 2 is a view in cross section of a glazing according to a first embodiment of the invention;

FIG. 3 is a view in cross section of a glazing according to a second embodiment of the invention.

The reference numerals that are identical in the various figures represent similar or identical elements.

It should be noted that the expression “between . . . and . . . ” includes the limits of the range.

The invention relates to a viscoelastic plastic interlayer intended to be incorporated between two glass sheets of a glazing to provide it with vibro-acoustic damping properties, the interlayer comprising:
two outer layers made of standard PVB,
a first and a second inner layers made of viscoelastic plastic material based on polyvinyl acetal and plasticizer, with improved acoustic properties,
a central layer made of standard PVB.

The first and the second inner layers are arranged, respectively, between the central layer and the first and second outer layers.

Thus, the interlayer comprises five layers in total, including three layers made of standard PVB between which are intercalated layers with noteworthy acoustic damping properties. This interlayer structure, in particular this alternation of more stiff and less damped layers and of less stiff and more damped layers, gives the glazing improved acoustic insulation properties, in particular within a frequency range of between 1000 Hz and 5000 Hz.

The interlayer according to the invention is intended to be incorporated between two glass sheets to form laminated glazing.

FIG. 2 shows a view in cross section of glazing according to a first embodiment of the invention.

The glazing comprises two glass sheets 1, 2 between which is inserted the interlayer according to the invention. The solid connection of the interlayer to the glass sheets is made by known means, for example by stacking the glass sheets and the interlayer and by passing the assembly into an autoclave.

The thickness of each glass sheet 1, 2 is, for example, between 0.5 mm and 3.0 mm for an application as motor vehicle glazing, for example a windshield, and between 0.5 mm and 15.0 mm for an application as glazing for buildings.

In the case of a windshield application, the glazing needless to say satisfies all of the conditions of United Nations rule No. 43 (known as rule R43) of resistance to hard impacts to ensure its mechanical strength.

In the case of a building application, the laminated glazing according to the invention may be used in its basic form or integrated into multiple glazing.

For a motor vehicle glazing application, the glass sheet 1 of the glazing is intended to be oriented facing the exterior of the vehicle, whereas the glass sheet 2 is intended to be oriented facing the interior of the vehicle. The glass sheet 1 is, for example, thicker than the glass sheet 2 such that the glazing affords better protection against external attack (inclement weather, projection of gravel, etc.). In the existing motor vehicle glazings, the thickness of the glass sheet 1 is generally 2.1 mm and the thickness of the glass sheet 2 is generally 1.6 mm. The glazing according to the invention may also comprise a glass sheet 1 that is 1.6 mm thick and a glass sheet 2 that is 1.2 mm thick, or a glass sheet 1 that is 1.4 mm thick and a glass sheet 2 that is 1.1 mm thick.

The interlayer is constituted by at least two inner layers 6, 7 made of viscoelastic plastic with improved vibro-acoustic damping properties. They are based on polyvinyl acetal and plasticizer. The content and nature of the plasticizer and the degree of acetalization of the polyvinyl butyral make it possible to modify in a known manner the stiffness of a component based on polyvinyl butyral and plasticizer.

In the example of FIG. 2, the interlayer also comprises three layers 3, 4, 5 made of polyvinyl butyral (PVB), referred to as standard PVB as opposed to the material of the inner layers 6, 7 which is based on polyvinyl acetal and plasticizer and which is less stiff and more damping than “standard” PVB.

The three layers 3, 4, 5 made of standard PVB are named outer layers for layers 4 and 5 and central layer for layer 3. The outer layers 4, 5 and the central layer 3 have a shear modulus G′ of greater than or equal to 1×10⁸ Pa and a tan δ loss factor of less than 0.4, at 20° C. and within a frequency range of between 1 kHz and 10 kHz. The outer layers 4, 5 and the central layer 3 give the interlayer good mechanical strength.

The inner layers 6, 7 are less stiff than the outer layers 4, 5 and the central layer 3 so as to give the interlayer improved acoustic properties.

The outer layers 4, 5 are in contact with the glass sheets 1, 2, respectively. The two layers 6, 7 are each intercalated between one of the outer layers 4, 5 and the central layer 3.

Depending on the application, the first and the second inner layers 6, 7 may have the same chemical composition or a different chemical composition.

Furthermore, in order to optimize the sound transmission loss, the central layer 3 and the outer layers 4, 5 each have a thickness of between 0.10 mm and 0.40 mm and the inner layers 6, 7 each have a thickness of between 0.10 mm and 0.20 mm, the total thickness of the interlayer being between 0.70 mm and 2.00 mm.

FIG. 3 represents a view in cross section of glazing according to a second embodiment of the invention.

This glazing differs from that of FIG. 2 only by the fact that the central layer 3 is constituted of two layers 3a, 3b made of standard PVB, which are superposed. That which was stated above regarding the embodiment of FIG. 2 is valid for the embodiment of FIG. 3.

To produce this glazing according to FIG. 3, two acoustic three-layer interlayers A and B are superposed. Each three-layer interlayer A, B comprises two layers made of standard PVB, respectively 4, 3a and 3b, 5 between which is arranged a layer 6 or 7 made of viscoelastic plastic material based on polyvinyl acetal and plasticizer, with improved acoustic properties.

Thus, the interlayer according to the invention may be made either from five independent layers, or from two existing three-layer interlayers.

As will be seen later, in connection with FIG. 1, the fact that the interlayer comprises two layers with improved acoustic properties, intercalated between three layers made of standard PVB, makes it possible to improve the acoustic performance qualities of the glazing, in particular between 1000 Hz and 5000 Hz.

The acoustic characteristics of the interlayer are determined by measuring the mechanical impedance (MIM) at 20° C. according to standard ISO 16940 of a laminated glazing bar with a surface area of 25 mm×300 mm composed of two glass sheets 2.1 mm thick (and not 4 mm as recommended in standard ISO 16940), between which is incorporated an interlayer according to the invention, i.e. an interlayer comprising at least two inner layers made of viscoelastic plastic with improved vibro-acoustic damping properties, located between three outer and central layers made of standard PVB.

MIM makes it possible to determine the resonant frequencies and the loss factors of the various mechanical impedance modes of the laminated glazing bar.

The interlayer is in accordance with the invention if the resonant frequency f₁ of the first resonance mode of a laminated glazing bar with a surface area of 25 mm×300 mm composed of two glass sheets each 2.1 mm thick between which is incorporated the interlayer, determined by mechanical impedance measurement (MIM) at 20° C. according to standard ISO 16940, is between 100 Hz and 200 Hz and the modal damping η₁ of said first resonance mode of said bar, determined by MIM under the same conditions, is greater than or equal to 0.35.

Preferably, the resonant frequency f₁ is between 120 Hz and 180 Hz and the loss factor η₁ is greater than or equal to 0.38, or even 0.40, which makes it possible to obtain further improved acoustic performance qualities, in particular between 1000 Hz and 5000 Hz.

FIG. 1 shows a curve of measurement of the sound transmission loss (STL) as a function of the frequency, evaluated on three laminated glazings according to standard NF EN ISO 10140 (with the exception of the size of the glazing, which is based on a size of 500 mm by 800 mm).

Thus, a first laminated glazing (Sample 1—reference 1) comprises:
two glass sheets each having a thickness of 2.1 mm, and
an interlayer No. 1 comprising two outer layers made of standard PVB and an inner layer made of viscoelastic plastic with improved vibro-acoustic damping properties.

The resonant frequency f₁ is 138 Hz (±5 Hz) and the loss factor η₁ is equal to 0.27 (±0.05).

The first laminated glazing corresponds to a standard windshield glass composition with an interlayer of known acoustic damping properties. The interlayer No. 1 could, for example, be replaced by the interlayer Trosifol VG+SC sold by Kuraray or by the interlayer Saflex® Vanceva Quiet QC41 sold by Solutia or alternatively by the interlayer S-Lec Acoustic Film HI-RZN12 sold by Sekisui. This is the reference laminated glazing 1.

The sound transmission loss curve for the first laminated glazing is represented by circles.

A second laminated glazing (Sample 2—reference 2) comprises:
two glass sheets each having a thickness of 2.1 mm, and
an interlayer No. 2 comprising two outer layers made of standard PVB and an inner layer made of viscoelastic plastic with improved vibro-acoustic damping properties.

The resonant frequency f₁ is 175 Hz (±5 Hz) and the loss factor η₁ is equal to 0.27 (±0.05).

The second laminated glazing corresponds to a standard windshield glass composition with an interlayer of known acoustic damping properties. The interlayer No. 2 is the interlayer described in WO 2016/175 101. This is the reference laminated glazing 2.

The sound transmission loss curve for the second laminated glazing is represented by diamonds.

A third laminated glazing (Sample 1+2) comprises:
two glass sheets each having a thickness of 2.1 mm, and
an interlayer constituted of a three-layer interlayer No. 1 and a three-layer interlayer No. 2, which are superposed.

The resonant frequency f₁ is 146 Hz (±5 Hz) and the loss factor η₁ is equal to 0.42 (±0.05).

The third laminated glazing corresponds to laminated glazing according to the invention.

The sound transmission loss curve (represented by triangles) for the third laminated glazing shows an improvement in the sound transmission loss between 500 Hz and 5000 Hz relative to the first and second reference laminated glazings, and even an improvement in the acoustic insulation over the entire frequency range (500 Hz-8000 Hz) relative to the first laminated glazing. A noteworthy effect may thus be observed resulting from the assembling of several layers of viscoelastic materials with different properties and natures (in terms of damping and of mechanical stiffness), the assembly of which describes a new-generation acoustic PVB that is both more damped while at the same time being stiffer than a standard acoustic PVB. A synergistic effect may thus be observed between the two three-layer interlayers No. 1 and No. 2 between 500 Hz and 5000 Hz, which is no longer true at higher frequencies.

The invention also relates to laminated glazing comprising:
two glass sheets each having a thickness of 2.1 mm, and
an interlayer constituted of two superposed three-layer interlayers No. 1.

The evaluated resonant frequency f₁ is 128 Hz (±5 Hz) and the evaluated loss factor η₁ is equal to 0.41 (±0.05).

The invention also relates to laminated glazing comprising:
two glass sheets each having a thickness of 2.1 mm, and
an interlayer constituted of two superposed three-layer interlayers No. 2.

The evaluated resonant frequency f₁ is 168 Hz (±5 Hz) and the evaluated loss factor η₁ is equal to 0.42 (±0.05).

The three-layer interlayers No. 1 and No. 2 have different chemical compositions, but are based on polyvinyl acetal and plasticizer, with improved acoustic properties and are indeed such that, when they are superposed in pairs (No. 1+No. 1 or No. 1+No. 2 or No. 2+No. 2), the resonant frequency f₁ of the first resonance mode of a laminated glazing bar with a surface area of 25 mm×300 mm composed of two glass sheets each 2.1 mm thick between which is incorporated the interlayer, determined by mechanical impedance measurement (MIM) at 20° C. according to standard ISO 16940, is between 100 Hz and 200 Hz and the modal damping η₁ of said first resonance mode of said bar, determined by MIM under the same conditions, is greater than or equal to 0.35, or even greater than or equal to 0.38, or even greater than or equal to 0.40.

All of the examples are laminated glazings with two glass sheets each 2.1 mm thick. However, as indicated at the start of the description, all the laminated glazings with glass sheets with a thickness of between 0.5 mm and 15.0 mm and a five-layer interlayer, including three layers of standard PVB between which are located two inner layers that are softer than standard PVB, the central layer possibly being divided, form part of the invention.

The MIM measurements were taken once a week for several weeks. The values given here are the values obtained after stabilization, i.e. typically at least 10 weeks after assembling the laminated glazing bar.

The interlayer according to the invention may also:
be tinted in the bulk on a part of its surface, to respect the intimacy of persons inside a vehicle or to protect the driver of a vehicle from being dazzled by sunlight or simply for an esthetic effect, and/or
have a cross section decreasing in a wedge shape from the top to the bottom of the laminated glazing to allow the laminated glazing to be used as a head-up display (HUD) system screen, and/or
comprise particles serving to screen out infrared radiation to limit the rise in temperature inside a vehicle due to the infrared radiation of the sun, to improve the passenger comfort.

1. A viscoelastic plastic interlayer intended to be incorporated between two glass sheets of a glazing to provide the glazing with vibro-acoustic damping properties, the interlayer comprising:
two outer layers made of standard PVB,
first and second inner layers made of viscoelastic plastic material based on polyvinyl acetal and plasticizer, with improved acoustic properties,
a central layer made of standard PVB,
the first and the second inner layers being arranged, respectively, between the central layer and the first and second outer layers.

2. The interlayer according to claim 1, in which the outer layers and the central layer have a shear modulus G′ of greater than or equal to 1×10⁸ Pa and a tan δ loss factor of less than 0.4, at 20° C. and within a frequency range of between 1 kHz and 10 kHz.

3. The interlayer according to claim 1, in which the interlayer is such that the resonant frequency f₁ of the first resonance mode of a laminated glazing bar with a surface area of 25 mm×300 mm composed of two glass sheets each 2.1 mm thick between which is incorporated the interlayer, determined by mechanical impedance measurement (MIM) at 20° C. according to standard ISO 16940, is between 100 Hz and 200 Hz and the modal damping η₁ of said first resonance mode of said bar, determined by MIM under the same conditions, is greater than or equal to 0.35.

4. The interlayer according to claim 1, in which the interlayer is such that the resonant frequency f₁ of the first resonance mode of a laminated glazing bar with a surface area of 25 mm×300 mm composed of two glass sheets 2.1 mm thick between which is incorporated the interlayer, determined by mechanical impedance measurement (MIM) at 20° C. according to standard ISO 16940, is between 120 and 180 Hz and the modal damping η₁ of said first resonance mode of said bar, determined by MIM under the same conditions, is greater than or equal to 0.38.

5. The interlayer according to claim 1, in which the first and the second inner layers have a different composition.

6. The interlayer according to claim 1, in which the central layer and the outer layers each have a thickness of between 0.10 mm and 0.40 mm and the inner layers each have a thickness of between 0.10 mm and 0.20 mm, the total thickness of the interlayer being between 0.70 mm and 2.00 mm.

7. The interlayer according to claim 1, in which the central layer is constituted of two layers made of standard PVB, the interlayer being constituted of two superposed three-layer interlayers, each three-layer interlayer comprising two layers made of standard PVB between which is arranged a layer made of viscoelastic plastic material based on polyvinyl acetal, with improved acoustic properties.

8. The interlayer according to claim 1, the interlayer being tinted in the bulk on a part of a surface and/or having a cross section decreasing in a wedge shape from the top to the bottom of a laminated glazing into which the interlayer is intended to be incorporated and/or comprising particles serving to screen out infrared radiation.

9. A laminated glazing comprising:
a glass sheet with a thickness of between 0.5 mm and 3.0 mm,
a glass sheet with a thickness of between 0.5 mm and 3.0 mm,
the interlayer as claimed in claim 1, the interlayer being between the glass sheets.

10. A laminated glazing comprising:
a glass sheet with a thickness of between 0.5 mm and 15.0 mm,
a glass sheet with a thickness of between 0.5 mm and 15.0 mm,
the interlayer as claimed in claim 1, the interlayer being between the glass sheets.

11. The laminated glazing according to claim 9, wherein the laminated glazing is a motor vehicle glazing.

12. The laminated glazing according to claim 10, wherein the laminated glazing is a glazing for buildings, either as single glazing, or integrated into multiple glazing.

13. The interlayer according to claim 1, in which the interlayer is such that the resonant frequency f₁ of the first resonance mode of a laminated glazing bar with a surface area of 25 mm×300 mm composed of two glass sheets 2.1 mm thick between which is incorporated the interlayer, determined by mechanical impedance measurement (MIM) at 20° C. according to standard ISO 16940, is between 120 and 180 Hz and the modal damping η₁ of said first resonance mode of said bar, determined by MIM under the same conditions, is greater than or equal to 0.40.
